(19) United States
(12) Patent Application Publication
(10) Pub. No.: US 2011/0085834 A1
(43) Pub. Date: Apr. 14, 2011

(54) Cleaning device and image forming apparatus incorporating same

(76) Inventors: Osamu Naruse, Yokohama-shi (JP); Kenji Sugiura, Yokohama-shi (JP); Naomi Sugimoto, Kawasaki-shi (JP); Hisashi Kikuchi, Kawasaki-shi (JP); Yoshiki Hozumi, Sagamihara-shi (JP); Yuu Sakakibara, Zama-shi (JP)

(21) Appl. No.: 12/923,856

(22) Filed: Oct. 12, 2010

(30) Foreign Application Priority Data
Oct. 13, 2009 (JP) 2009-235984
May 31, 2010 (JP) 2010-124490

(51) Int. Cl. G03G 21/00

(52) U.S. Cl. 399/350

(57) ABSTRACT

A cleaning device for an electrophotographic image forming apparatus includes a primary cleaning brush, a collecting roller, and a blade. The primary cleaning brush is configured to remove post-transfer residual toner remaining on an image carrying member. The collecting roller is configured to cause the post-transfer residual toner adhering to the first cleaning brush to electrostatically adhere thereto, is made of metal, and has a surface roughness Ra of at least approximately 0.08 micrometers. The blade is configured to come into contact with the collecting roller and mechanically remove the post-transfer residual toner adhering to the collecting roller.

### CROSS-REFERENCE TO RELATED APPLICATIONS

The present invention claims priority pursuant to 35 U.S.C. §119 from Japanese Patent Application No. 2009-235984, filed on Oct. 13, 2009 in the Japan Patent Office, and Japanese Patent Application No. 2010-124490, filed on May 31, 2010 in the Japan Patent Office, which are hereby incorporated by reference herein in their entirety.

### BACKGROUND OF THE INVENTION

1. Field of the Invention

The present invention relates to a cleaning device and an image forming apparatus, more particularly to a cleaning device and an image forming apparatus using a method of removing post-transfer residual toner adhering to a cleaning brush by causing the residual toner to electrostatically adhere to a collecting roller.

2. Description of the Background Art

According to the electrophotographic method, a surface of an image carrying member (e.g., photoconductor drum) is uniformly charged to a positive or negative charge by a charging device, and is subjected to exposure in accordance with an original image to form an electrostatic latent image. Then, the electrostatic latent image on the image carrying member is developed by a development device with toner charged to the opposite polarity to the polarity of the latent image, and a resultant toner image is transferred by a transfer device onto a transfer sheet such as a paper sheet or an intermediate transfer medium. Post-transfer residual toner remaining on the image carrying member is removed from the image carrying member by a cleaning device to leave no toner on the surface of the image carrying member and recycle the removed residual toner to the charging device. With this configuration, it is possible to repeatedly use the toner.

The cleaning methods commonly used by this type of cleaning device include the blade cleaning method and the brush roller method using a conductive or insulative brush roller. Among existing commonly used cleaning methods, the blade cleaning method has been often used because it is inexpensive and simple in configuration and mechanically stems the toner.

Meanwhile, toner particles have been undergone a reduction in diameter due to recent demand for higher image quality. Further, in the production of toner, the polymerization method has become the most common method of manufacturing particulate toner due to its energy efficiency. Moreover, the polymerization method, which uses spherically shaped toner particles and therefore does not include a process of deforming toner particle deformation, is relatively inexpensive. In addition, forming toner particles into a spherical shape results in an increase in transfer efficiency and a reduction in waste toner originating from the post-transfer residual toner, and thus is considered to enhance the energy saving effect.

However, when cleaning off small-diameter spherical toner particles produced by the polymerization method with the use of a blade, it is difficult to stem the toner particles unless the blade is pressed against the image carrying member with relatively strong force. Pressing the blade with relatively strong force accelerates the abrasion of the blade and the surface layer of the image carrying member. Further, when the blade is pressed with relatively strong force, a motor torque for driving the image carrying member needs to be increased.

Meanwhile, there is an increasing need for a wider range of options for recording sheets. To satisfy such a need, e.g., to form an image on a recording sheet having a relatively rough surface or a relatively thick recording sheet, it is necessary to increase the thickness and elasticity of an intermediate transfer belt on which the recording medium is conveyed. If such an elastic belt is cleaned using a conventional rubber blade, however, the blade may bite into the belt and fail to clean the belt.

In view of the above, a method using an electrostatic brush roller for absorbing toner with electrostatic force has been studied as a method for reducing the damage to the image carrying member to achieve better durability and a reduction in running costs, cleaning off small-diameter and highly spherical toner particles, and cleaning an elastic intermediate transfer belt.

For example, according to a first background cleaning device, residual toner remaining on an image carrying member is scraped off by a, cleaning blade and a fur brush, and the fur brush is brought into contact with a collecting roller. Further, a voltage is applied to the collecting roller such that the collecting roller electrostatically collects the toner from the fur brush. Then, the toner is scraped off the collecting roller by a scraper pressed against the collecting roller. The surface roughness of the collecting roller is set to be at least 3 μm (micrometers) and not to exceed 20 μm on the ten-point mean surface roughness scale. Further, a solid lubricant is pressed against a surface of the collecting roller. In the background cleaning device, the surface roughness is controlled to cause the collecting roller to stably scrape off the solid lubricant. With the above-described surface roughness, which is approximately 0.8 μm to 5 μm on the Ra (i.e., arithmetic mean roughness) scale, the requisite lubricant scraping performance is obtained. Due to the relatively rough surface of the collecting roller, however, the cleaning performance of the collecting roller is degraded.

A second background cleaning device includes brush rolls, collecting rollers, and toner scraping members. Each of the brush rolls is made of conductive fiber for electrostatically absorbing toner remaining on an image carrying member. Each of the collecting rollers has a surface for electrostatically collecting the toner absorbed by the corresponding brush roll. The surface of the collecting roller includes a high-resistivity layer having a volume resistivity of at least 7 log Ω·cm (logarithmic ohm centimeters) and not exceeding 13 log Ω·cm. Each of the toner scraping members scrapes off the toner collected by the corresponding collecting roller. According to the configuration, however, the high-resistivity layer of the collecting roller is formed by a conductive material different from the material forming a core of the collecting roller. Therefore, the resistance fluctuates with temperature and humidity, and thus stable cleaning performance is not obtained.

A third background cleaning device removes and collects residual toner remaining on an image carrying member. The cleaning device includes a brush roller which rotates while in contact with a surface of the image carrying member, and a collecting roller which rotates while in contact with the brush roller. The collecting roller includes a core bar, a cylindrical member surrounding the outer circumference of the core bar and forming a resistive layer, and an intermediate conductive layer interposed between the core bar and the cylindrical member. According to the configuration, however, the collecting roller has a two-layer structure in which the resistive layer is formed around the outer circumference of the core bar, and thus increases costs.

A fourth background cleaning device includes a rotary cleaning member which collects residual toner remaining on an image carrying member, and a rotary detoning member which is arranged to face the rotary cleaning member and to which waste toner on the rotary cleaning member is electrostatically transferred. The rotary detoning member includes a conductive core member and a covering layer for covering the core member. The covering layer has a volume resistivity of at least 10⁹Ω·cm, a dynamic hardness of at least 20, and a maximum surface roughness not exceeding 5 μm. According to the configuration, however, if the rotary detoning member has a volume resistance, stable electrostatic cleaning is prevented due to environmental changes. Further, the maximum surface roughness not exceeding 5 μm may cause a cleaning failure in cleaning toner particles having a small diameter of 4 μm to 5 μm.

As described above, in a cleaning device included in an electrophotographic image forming apparatus, toner removed from an image carrying member by brush cleaning is removed from a brush. Otherwise, the toner accumulates in an area near the core bar of the brush, i.e., at the roots of the brush, and eventually stiffens the brush into a roll. For this reason, the toner adhering to the brush needs to be removed therefrom by some sort of device.

As the method for removing the toner from the brush, there is a method of covering the entire brush with a cover and vacuum-suctioning and collecting the toner from the brush. However, the vacuum-suctioning is performed with the entire brush roller covered with a cover. Therefore, the volume of a suction machine is increased, and the overall size of the device is increased. Further, the noise accompanying the cleaning operation is increased.

There is another method that electrostatically transfers toner on a brush roller 22 to a collecting roller 23 and mechanically removes the toner from the collecting roller 23 with the use of a collecting blade 24. According to the method, however, the cleaning at the final stage is performed with the collecting blade 24 brought into contact with the collecting roller 23, and thus an edge of the collecting blade 24 typically made of urethane rubber is worn due to the sliding friction thereof with the collecting roller 23. As a result, a cleaning failure occurs, and long-term durability is not attained.

### SUMMARY OF THE INVENTION

This patent specification describes an improved cleaning device for an electrophotographic image forming apparatus. In one embodiment, a cleaning device for an electrophotographic image forming apparatus includes a first cleaning brush, a collecting roller, and a blade. The first cleaning brush is configured to remove post-transfer residual toner remaining on an image carrying member. The collecting roller is configured to cause the post-transfer residual toner adhering to the first cleaning brush to electrostatically adhere thereto, is made of metal, and has a surface roughness Ra of at least approximately 0.08 micrometers. The blade is configured to come into contact with the collecting roller and mechanically remove the post-transfer residual toner adhering to the collecting roller.

The surface roughness Ra of the collecting roller may not exceed approximately 1.6 micrometers.

The blade may be made of metal, and include a section coming into contact with the collecting roller and having a surface roughness Ra not exceeding approximately 2.0 micrometers.

The angle of contact of the blade with the collecting roller may be at least approximately 15 degrees.

This patent specification further describes an improved image forming apparatus. In one embodiment, an image forming apparatus includes the above-described cleaning device.

The toner may be produced by a polymerization method.

The toner may be produced by a pulverization method subjected to an ensphering process using heat treatment.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a diagram illustrating a schematic configuration of an image forming apparatus according to an embodiment of the present invention;

FIG. 2 is a diagram illustrating a schematic configuration of an image forming unit included in the image forming apparatus of FIG. 1;

FIG. 3 is a diagram illustrating a schematic configuration of a cleaning device included in the image forming apparatus of FIG. 1;

FIG. 4 is a first diagram for explaining a concept of electrostatic cleaning;

FIG. 5 is a second diagram for explaining the concept of electrostatic cleaning;

FIG. 6 is a diagram illustrating second cleaning performance of an embodiment of the present invention;

FIG. 7 is a diagram illustrating third cleaning performance of the embodiment of the present invention;

FIG. 8 is a diagram illustrating third cleaning performance of another embodiment of the present invention;

FIG. 9 is a diagram for explaining a contact angle in the another embodiment of the present invention; and

FIG. 10 is a diagram illustrating an example in which an area A illustrated in FIG. 9 is enlarged and the surface roughness thereof is measured.

### DETAILED DESCRIPTION OF PREFERRED EMBODIMENTS

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner and achieve a similar result.

Referring now to the drawings, wherein like reference numerals designate identical or corresponding parts throughout the several views, preferred embodiments of the present invention will be described.

Overall Configuration:

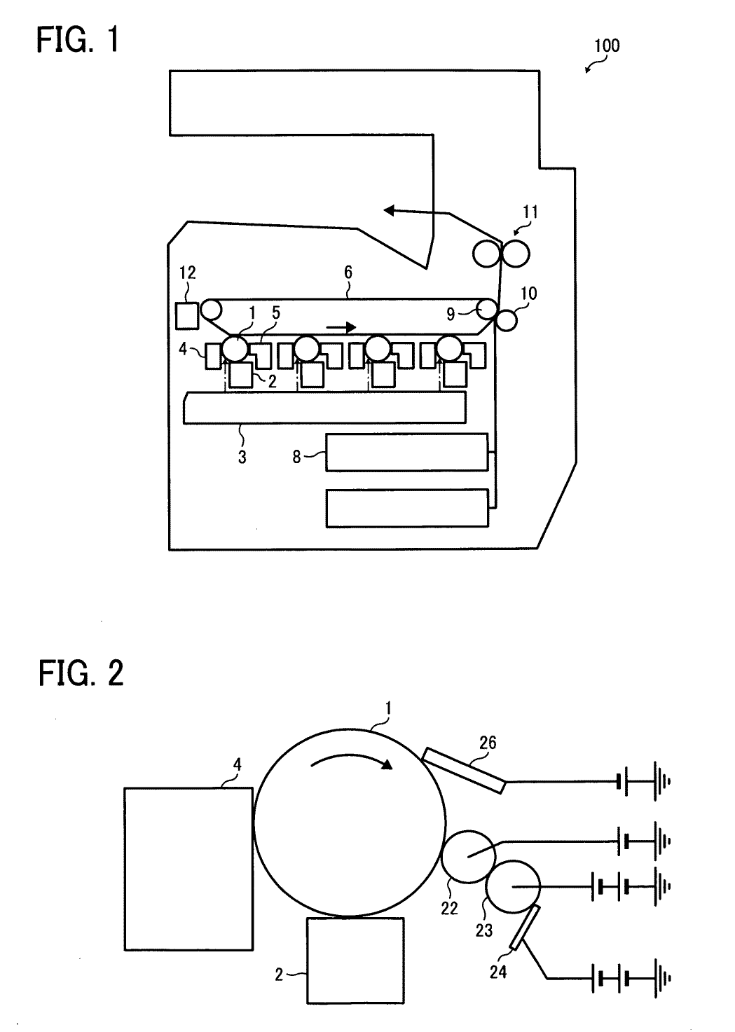

FIG. 1 is a diagram illustrating a schematic configuration of an image forming apparatus 100 according to an embodiment of the present invention. FIG. 1 illustrates an image carrying drum (i.e., image carrying member) 1, a charging device 2, an exposure device 3, a development device 4, a cleaning device 5, an image carrying belt (i.e., image carrying member) 6, a primary transfer roller 7, a sheet feeding tray 8, an opposite transfer roller 9, a secondary transfer roller 10, a fixing device 11, and a cleaning device 12.

Image forming units Y (yellow), M (magenta), C (cyan), and B (black) included in the image forming apparatus 100 will now be described, with the image forming unit Y taken as an example. The image carrying drum 1, the charging device 2, the development device 4, and the cleaning device 5 illustrated on the left side in FIG. 1 form the image forming unit Y, and the other three image forming units M, C, and B are located on the right side of the image forming unit Y. The image carrying drum 1 is formed by a conductive base member made of aluminum or the like and having a surface covered by, for example, an organic semiconductor thin film, and rotates in the clockwise direction. A surface of the image carrying drum 1 is uniformly charged to a negative potential by the charging device 2 and subjected to exposure by the exposure device 3. Thereby, an electrostatic latent image is formed which corresponds to a separation image of an input document including image components separated by color. Then, the development device 4 performs reversal development by using a negatively charged toner. Thereby, a toner image corresponding to the electrostatic latent image is formed on the surface of the image carrying drum 1. The toner image formed on the image carrying drum 1 is then transferred by the primary transfer roller 7 onto the image carrying belt 6 driven to rotate at the same speed as the speed of the image carrying drum 1.

The above-described operation is performed in each of the image forming units Y, M, C, and B, and the toner images formed on the respective image carrying drums 1 of the image forming units Y, M, C, and B are multiply transferred onto the image carrying belt 6. In a full-color mode, the color toner images are transferred onto the image carrying belt 6 in the order of Y, M, C, and B. Similarly, in a single-color mode or a two- or three-color mode, necessary color toner images are multiply transferred onto the image carrying belt 6 in the above-described order. Then, a synthetic toner image formed by the multiple transfer is subjected to secondary transfer by the opposite transfer roller 9 and the secondary transfer roller 10 to be transferred onto a recording sheet (i.e., recording medium) fed from the sheet feeding tray 8 by conveying rollers (not illustrated). Then, the toner image subjected to the secondary transfer is fixed on the recording sheet with heat and pressure applied by the fixing device 11.

Meanwhile, the cleaning device 5 collects residual toner remaining on the image carrying drum 1 to prepare the image carrying drum 1 for the next image forming operation. Further, the cleaning device 12 cleans the image carrying belt 6 subjected to the secondary transfer to clean off dirt adhering to a surface of the image carrying belt 6, such as post-secondary transfer residual toner and paper dust. The cleaning device 5 is illustrated in FIG. 2, and the cleaning device 12 is illustrated in FIG. 1.

FIG. 2 illustrates one of the image forming units (alternatively referred to as photoconductor units) Y, M, C, and B. The image forming unit, which includes the image carrying drum 1, the charging device 2, the development device 4, and the cleaning device 5, is replaceable. A polar blade 26, a collecting roller 23, a brush roller 22, and a collecting blade 24 illustrated in FIG. 2 form the cleaning device 5 illustrated in FIG. 1.

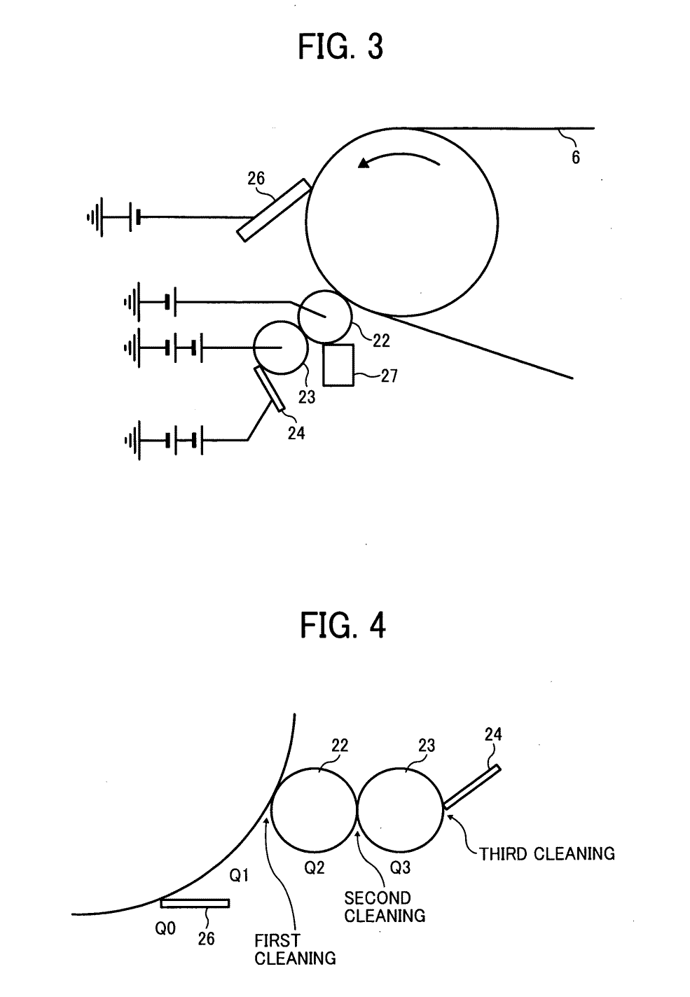

FIG. 3 illustrates the cleaning device 12 illustrated in FIG. 1. The cleaning device 12, which cleans the image carrying belt 6, includes the polar blade 26, the collecting roller 23, the brush roller 22, the collecting blade 24, and a paper dust roller 21 installed upstream of the above-described blades and rollers. The paper dust roller 21 is provided to remove paper dust and talc dropped from paper forming the recording sheet, which comes into contact with the image carrying belt 6. FIG. 3 also illustrates a lubricant 27, which may be removed from the cleaning device 12.

In FIGS. 2 and 3, the polar blade 26 may be replaced by the brush roller 22, the collecting roller 23, and the collecting blade 24. Post-transfer residual toner has a charge. Therefore, an existing typical brush cleaning device uses the characteristics of the charge, i.e., causes a brush to absorb and remove the residual toner by applying to the brush a voltage opposite in polarity to the residual toner. In many cases, the charge of the residual toner has both positive and negative polarities due to discharge. Generally, the bias voltage applied in the transfer process has a positive polarity. Therefore, post-development toner having a negative polarity is absorbed and transferred. Meanwhile, untransferred toner escapes the cleaning device and proceeds to subsequent processes.

As described above, however, discharge occurs between transfer media due to the transfer voltage. In reality, therefore, the residual toner is not charged to only one polarity, but is charged to both positive and negative polarities. In view of this, the configuration may be modified to provide two sets of the brush rollers 22, the collecting rollers 23, and the collecting blades 24, and to apply a positive voltage to the brush roller 22, the collecting roller 23, and the collecting blade 24 forming one of the two sets and apply a negative voltage to the brush roller 22, the collecting roller 23, and the collecting blade 24 forming the other set. Meanwhile, in the system illustrated in FIGS. 2 and 3, the charge of the residual toner is aligned to one polarity by the polar blade 26 serving as a polarity control member, and the brush roller 22 is applied with a voltage having a polarity opposite to the aligned polarity to absorb the residual toner.

Electrostatic Cleaning:

A conceptual diagram of electrostatic cleaning is illustrated in FIG. 4 described above. In the transfer process, if the post-development toner having a negative polarity is applied with a positive transfer voltage, all of the toner is supposed to be transferred to a medium such as a recording sheet and an intermediate transfer belt. However, an electric field is generated in a relatively narrow gap, and thus separating discharge occurs. As a result, post-transfer residual toner having a charge amount Q0 has a mixture of positive and negative polarities. Thus, the mixture of positive and negative polarities in the residual toner is aligned to one polarity by the polar blade 26 such that the residual toner has either one of positive and negative polarities. Then, the residual toner is caused to adhere to the brush roller 22 with electrostatic force greater than the electrostatic force which keeps the residual toner adhering to the image carrying member. This process is referred to as first cleaning. Then, the residual toner adhering to the brush roller 22 and having a charge amount Q2 is moved to the collecting roller 23. This process is referred to as second cleaning. Finally, the residual toner adhering to the collecting roller 23 and having a charge amount Q3 is removed. This process is referred to as third cleaning. With the first to third cleanings, the residual toner remaining on the image carrying member is collected as waste toner.

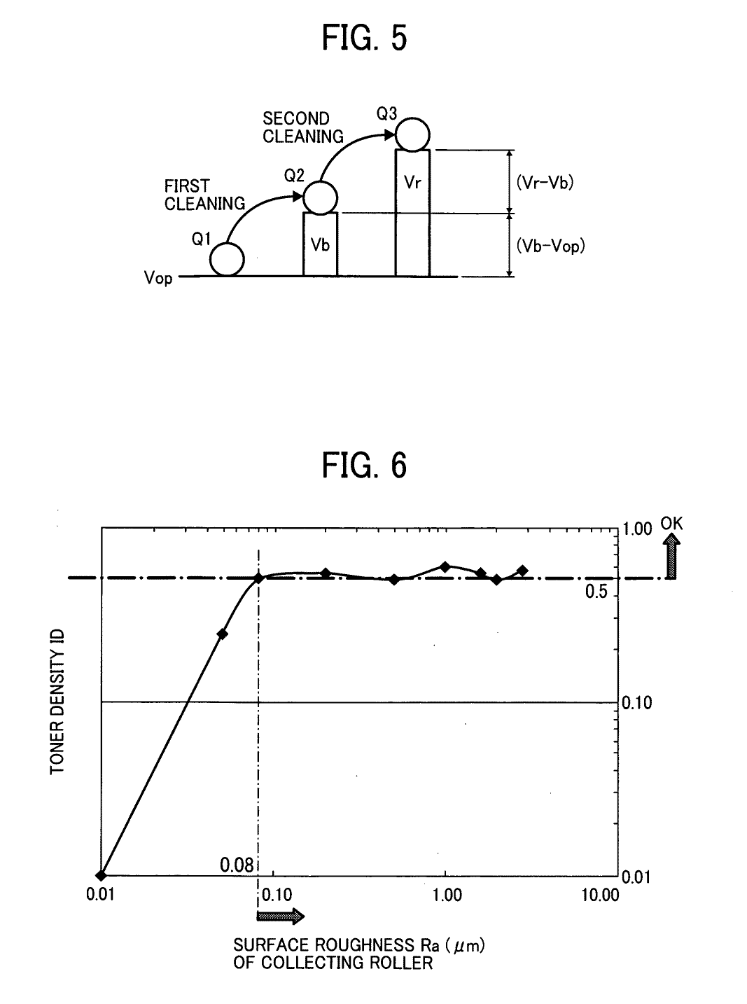

FIG. 5 illustrates a model of the movement of toner based on the potential difference. Herein, Vop represents the potential on the surface of the image carrying member, Vb represents the potential on the surface of the brush roller 22, and Vr represents the potential on the surface of the collecting roller 23. The product of the potential difference (Vb−Vop) between the image carrying member and the brush roller 22 and the charge amount Q1 and the product of the potential difference (Vr−Vb) between the brush roller 22 and the collecting roller 23 and the charge amount Q2 specify respective electrostatic forces. In accordance with the unequal relationship between the electrostatic forces, the residual toner sequentially moves between the components and collected by the third cleaning.

Image Carrying Belt:

The image carrying belt 6 is formed by a synthetic resin, such as polyimide, polycarbonate, polyester, and polypropylene, or any of various types of rubbers mixed with an appropriate amount of a conductive material such as carbon black. The volume resistivity of the image carrying belt 6 is approximately 10E6Ω·cm to approximately 10E14Ω·cm. The image carrying belt 6 having elasticity includes a conductive elastic layer and a conductive protective layer. A main base material of the conductive elastic layer includes silicone rubber, NBR (nitrile butadiene rubber), CR (chloroprene rubber), EPDM (ethylene propylene diene monomer), and urethane rubber. The material of the conductive protective layer is not particularly limited, as long as the material attains a reduction in coefficient of friction, stability of electric characteristics against environmental changes, and improvement of residual toner cleaning performance due to a reduction in surface roughness. The material of the conductive protective layer may include a paint containing a fluororesin-based polymer, such as PTFE (polytetrafluoroethylene), PFA (copolymer of tetrafluoroethylene and perfluoroalkylvinylether), and PVDF (polyvinylidene difluoride), dissolved or dispersed in an alcohol-soluble nylon-based, silicone-based, silane coupler, or urethane resin-based emersion or organic solvent. The protective layer may be provided by the above-described paint applied by dip coating, spray coating, electrostatic painting, roll coating, and so forth. Further, if the protective layer is subjected to surface treatment or polishing, releasability, conductivity, abrasion resistance, and surface cleaning performance are improved.

Polar Blade:

The polar blade 26 serving as a polarity control member is a component for aligning the polarity of the post-transfer toner. The post-transfer toner has a mixture of positive and negative polarities. In accordance with the polarity applied to the polar blade 26, therefore, the polarity of the toner shifts due to a phenomenon of charge injection or discharge. The polar blade 26 has another important function of controlling the amount of toner input to the brush roller 22. An increase in the amount of toner input to the brush roller 22 results in insufficient cleaning of the toner by the brush roller 22. Unlike the surface of a roller, the surface of a brush does not entirely come into contact with an image carrying member. Instead, toner corresponding to brush fiber implanted in the brush comes into contact with the brush fiber and adheres to the brush due to electrostatic force, and thereby the image carrying member is cleaned. As described above, a blade is limited in cleaning small-diameter spherical toner particles. To obtain long-term stable cleaning performance, therefore, typical pressing force applied to press the blade onto the image carrying member needs to be increased by at least approximately five times. The application of such large force, however, leads to damage on the image carrying member and the blade and deterioration of durability of the components. Meanwhile, to cause the blade not to completely clean the toner remaining on the image carrying member but to reduce the toner to an amount that can be cleaned by the final cleaning with the brush, it is unnecessary to apply such large force to the blade. The blade is required to control the toner amount to the level manageable by the cleaning ability of the brush. Accordingly, the functions required of the present polar blade 26 include a toner charging function and a redundant toner scraping function. As for the material allowing the polar blade 26 to come into contact with the entire surface of the image carrying member without damaging the surface, an elastic material such as polyurethane, silicone, and fluororubber is preferred. Further, the polar blade 26 preferably has, as physical properties required thereof to be durable and resistant to environmental changes, a JIS-A (Japanese Industrial Standard-A) hardness HS (Hardness Spring) of approximately 65 degrees to approximately 80 degrees, a modulus of repulsion elasticity of approximately 15% to approximately 60% at a temperature of 23 degrees Celsius, a Young's modulus of approximately 50 kg/cm² (kilograms per square centimeter) to approximately 200 kg/cm², and a 100% modulus of approximately 60 kgf/cm² (kilogram force per square centimeter) to approximately 200 kgf/cm². As for the charge injection characteristics of the polar blade 26, if the polar blade 26 is made of a conductive substance and carbon, ion, or a hybrid thereof, and is set to have a surface resistivity of at least approximately 1.0E6 Ω/□ (ohms per square) to increase the injection efficiency while preventing discharge, a desired resistive region is obtained. Preferably, the voltage applied to the polar blade 26 is approximately −1000 volts to approximately −4000 volts. If the applied voltage is excessively low, the discharge efficiency is deteriorated. Meanwhile, if the applied voltage is excessively high, the surface potential of the image carrying member excessively takes on a negative polarity, and the adhesive force acting between the toner and the image carrying member is undesirably increased.

Brush Roller:

The brush roller 22 is required to include a conductive brush made of a material such as acryl, PET (polyethylene terephthalate), and polyester mixed with a conductive material. Further, the structure of the conductive brush is not simple dispersion of the conductive material over the surface thereof, but is a core-in-sheath structure in which the conductive material is inserted in the brush so as not to be exposed to the surface of the brush. If the conductive material is exposed to the surface, charge injection into the toner occurs and makes it difficult to maintain the potential Vb on the surface of the brush roller 22. Preferably, the resistance of the brush is approximately 10E4Ω to approximately 10E9Ω. A reduction in resistance tends to cause the charge injection into the toner. Meanwhile, an increase in resistance reduces the electric field intensity, and makes it difficult to secure an electric field for suctioning the toner, unless a relatively high voltage is applied. Further, the density of brush bristles is an important factor for increasing the probability of contact with the toner. At least approximately 70,000 bristles/in² (per square inch), preferably at least approximately 100,000 bristles/in² are required.

To increase the contact probability, the brush roller 22 is rotated in the opposite direction to the rotation direction of the image carrying member, and the linear velocity ratio of the brush roller 22 to the image carrying member is set to at least approximately 0.5. Thereby, a preferred state of contact is obtained. Another important factor is the tilt of the brush bristles. It is generally considered that the bristles of a brush are provided upright. If the brush bristles are provided upright, however, toner tends to come into contact with leading end portions of the brush bristles, in which the conductive material is exposed. Desirably, therefore, the brush is subjected to a brush tilting process or a brushing process such that the brush bristles are tilted in a direction not biting into the image carrying member along with the rotation of the image carrying member and have a structure preventing direct contact between the toner and the conductive material.

Collecting Roller:

The collecting roller 23 has a function of performing the second cleaning of absorbing and removing the toner from the brush roller 22 and a function of allowing the collecting blade 24 to clean the toner adhering to the surface of the collecting roller 23. Important factors in the second cleaning are force for transferring the toner to the collecting roller 23 in accordance with the charge amount of the toner and the intensity of the electric field generated between the brush roller 22 and the collecting roller 23, and physical force for holding the toner transferred to the collecting roller 23. The physical force is holding force for preventing the toner from moving back to the brush roller 22 during the cleaning of the collecting roller 23 by the collecting blade 24. The holding force is closely related to the surface roughness of the collecting roller 23. If the collecting roller 23 has a low surface roughness, e.g., has a mirror-like surface, the holding force is small, and thus the toner adheres again to the brush roller 22 due to sliding frictional force of the brush roller 22. Meanwhile, if the collecting roller 23 has a high surface roughness, i.e., has a surface with substantial irregularities, the third cleaning by the collecting blade 24 fails.

Collecting Blade:

The collecting blade 24 brought into contact with the collecting roller 23 is a component having an important function of establishing the electrostatic cleaning system by removing the toner at the final stage. A urethane blade has mainly been used in existing cleaning devices. Along with increasing demand for long-life components, however, a need for a more abrasion-resistant material has increased. In view of this, a metal such as stainless steel and phosphor bronze may be used as the material forming the collecting blade 24. Further, to extend the life of the collecting blade 24, the metal material may be plated with chrome and so forth to increase the hardness of the collecting blade 24 and thereby reduce the amount of abrasion thereof.

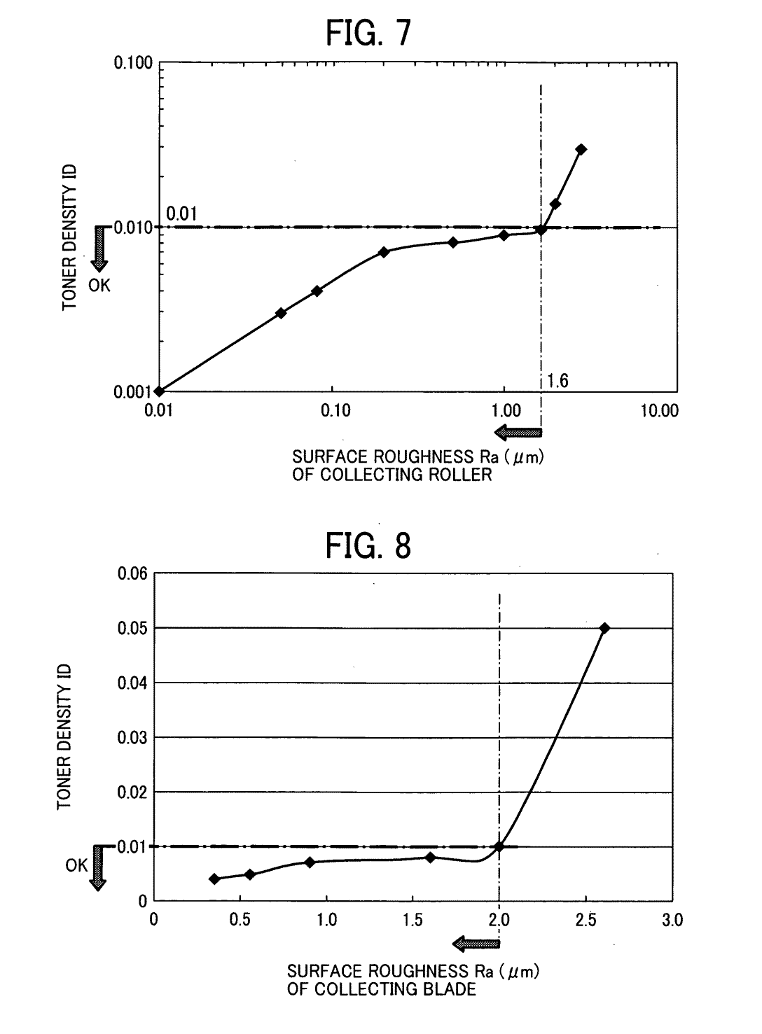

FIGS. 6 and 7 illustrate the relationship between the second and third cleanings in an embodiment of the present invention, with the surface roughness Ra of the collecting roller 23 set to different values. FIG. 6 illustrates the result of measurement of the toner density ID (Image Density) of the toner remaining on the collecting roller 23 measured by a densitometer manufactured by X-Rite, Incorporated. The measured toner was transferred to the collecting roller 23 in the cleaning by the brush roller 22 during an operation of printing ten untransferred images, which are solid patterns in a single color of cyan, without the installation of the collecting blade 24. Specifically, the number of printed images was set to ten to enhance the detection sensitivity in detecting the toner density ID on the collecting roller 23, in consideration that the solid patterns are removed by the polar blade 26. The polarity-controlled toner having passed the polar blade 26 after the continuous feeding of ten images was captured by the brush roller 22 and transferred to the collecting roller 23. The toner accumulated on the collecting roller 23 was then transferred onto an adhesive sheet Printac (registered trademark) manufactured by Print Technica K. K., and the adhesive sheet Printac was pasted on a high-quality paper sheet Type 6200 manufactured by Ricoh Company, Ltd. Then, the toner density was measured by a densitometer X-Rite 938. The toner density was measured at three points, i.e., front, center, and rear points in the longitudinal direction of the collecting roller 23. On the basis of the measured values, the toner density on the adhesive sheet Printac prior to the transfer was measured. Then, the mean of different density values between before and after the transfer was plotted on the vertical axis as the toner density ID of the collected toner. Meanwhile, the horizontal axis represents the surface roughness Ra of the collecting roller 23. The collecting roller 23 was manufactured by a material SUS (Steel Use Stainless) 303-G8. In the present example, nine rollers with different surface roughnesses Ra of approximately 0.01 μm to approximately 2.8 μm were manufactured as the collecting roller 23. The manufacturing methods of the rollers are as follows. The collecting roller 23 having a surface roughness Ra of approximately 0.01 μm was manufactured with the surface thereof finished by lapping. The collecting roller 23 having a surface roughness Ra of approximately 0.05 μm was manufactured with the surface thereof finished by buffing. The collecting roller 23 having a surface roughness Ra of approximately 0.08 μm was manufactured with the surface thereof finished by electro-polishing. Further, the collecting rollers 23 respectively having surface roughnesses Ra of approximately 0.2 μm, approximately 0.5 μm, approximately 1.0 μm, approximately 1.6 μm, approximately 2.0 μm, and approximately 2.8 μm were manufactured with different feed pitches of a lathe. The surface roughness was measured by a measuring instrument SURFCOM 1400D manufactured by Tokyo Seimitsu Co., Ltd. It is revealed from the experiment that the value of the toner density ID is saturated at a surface roughness Ra of approximately 0.08 μm, and that the collecting roller 23 needs a surface roughness Ra of at least approximately 0.08 μm to obtain toner collecting ability. That is, it is understood that, if the surface roughness Ra is reduced to be less than the above value, the toner adhering to the surface of the collecting roller 23 drops and the collecting roller 23 fails to obtain sufficient toner collecting ability.

FIG. 7 illustrates the performance of the third cleaning. In the present experiment, toner was caused to adhere to each of the above-obtained collecting rollers 23 to a toner density ID of approximately 0.5, and thereafter the collecting roller 23 was rotated one turn, installed with the collecting blade 24 manufactured by wire cutting and having a surface roughness Ra of approximately 0.55 μm.

The vertical axis represents the value of the toner density ID on the surface of the collecting roller 23 measured after the passage of the collecting roller 24, and the horizontal axis represents the surface roughness Ra of the collecting roller 23 described above. It is understood from the experiment that an increase in surface roughness results in the deterioration of the cleaning performance of the collecting blade 24, while a reduction in surface roughness improves the cleaning performance of the collecting blade 24. According to the specifications of the system, there is no problem if the toner density ID does not exceed approximately 0.01. It is therefore understood that there is no problem in practical use of the collecting roller 23, if the surface roughness Ra thereof does not exceed approximately 1.6 μm.

Accordingly, to obtain satisfactory performance of the second and third cleanings, the surface roughness Ra of the collecting roller 23 is preferably set to a range of approximately 0.08 μm to approximately 1.6 μm.

That is, in an electrostatic cleaning device including the brush roller 22, the collecting roller 23, the collecting blade 24, and voltage applying devices provided to the respective rollers, the collecting roller 23 is made of metal and has a surface roughness Ra in a range of approximately 0.08 μm to approximately 1.6 μm. With this configuration, it is possible to transfer toner from the brush roller 22 to the collecting roller 23, to obtain stable toner removal performance of the collecting blade 24 for removing the toner from the collecting roller 23, and to obtain long-term stable cleaning performance with little abrasion of the surface of the collecting roller 23.

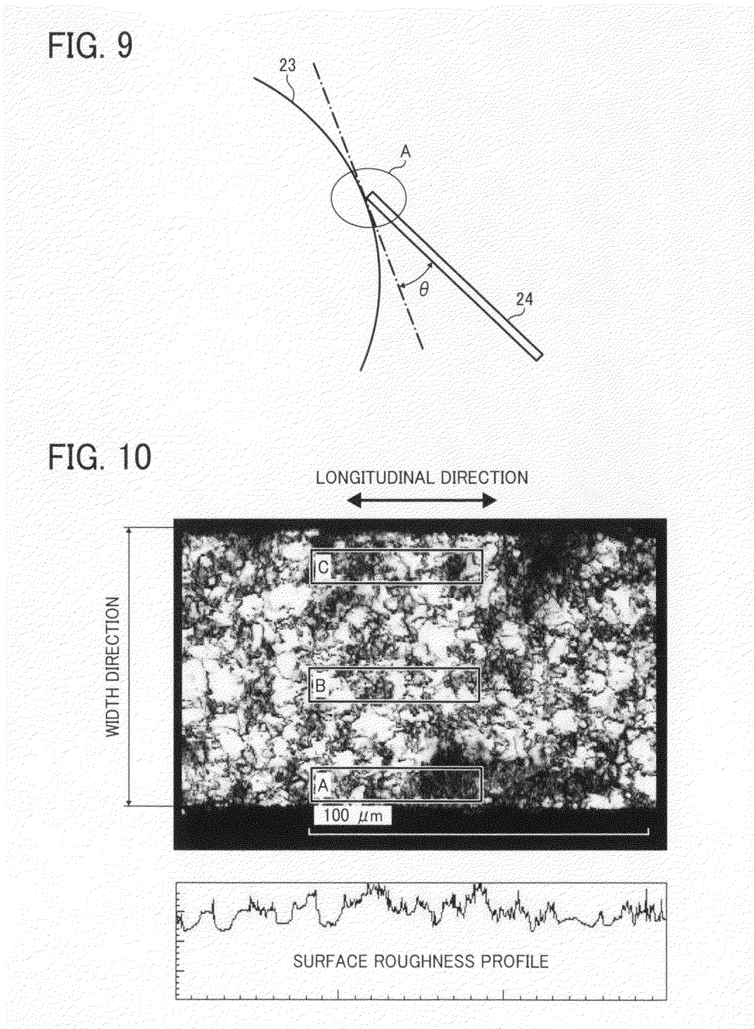

FIG. 8 illustrates the relationship between the toner density ID of the residual toner and the surface roughness Ra of a section of the collecting blade 24 in another embodiment of the present invention, with the surface roughness Ra of the section of the collecting blade 24 set to different values. In the present example, a SUS roller having a surface roughness Ra of approximately 0.5 μm was used as the collecting roller 23. As illustrated in FIG. 9, in which the collecting blade 24 is brought into contact with the collecting roller 23, the surface roughness of the section of the collecting blade 24 is herein defined as the surface roughness of a section of a leading end portion of the collecting blade 24 illustrated as an area A. FIG. 10 illustrates an example in which the area A is enlarged and the surface roughness thereof is measured by a microscope VK-8100 manufactured by Keyence Corporation. The width of the collecting blade 24, which is approximately 0.08 mm, is represented in the vertical direction, and the length of the collecting blade 24, which is approximately 310 mm, is represented in the horizontal direction. The profile of the surface roughness in the longitudinal direction is illustrated under the photograph. The level of the surface roughness Ra was changed from approximately 0.35 μm to approximately 2.6 μm. The manufacturing methods of the collecting blades 24 are as follows. The collecting blade 24 having a surface roughness Ra of approximately 0.35 μm was manufactured by etching. The collecting blades 24 respectively having surface roughnesses Ra of approximately 0.55 μm, approximately 0.9 μm, approximately 1.6 μm, and approximately 2.0 μm were manufactured by wire cutting with different wire feed speeds. Further, the collecting blade 24 having a surface roughness Ra of approximately 2.6 μm was manufactured by electro-discharge machining. It is understood from the experiment that, if the surface roughness Ra exceeds approximately 2.0 μm, the toner density ID exceeds the specified value of approximately 0.01. To meet the specification, therefore, the surface roughness Ra of the section of the collecting blade 24 is desired not to exceed approximately 2.0 μm.

Further, a cleaning experiment was conducted with the use of the collecting blade 24 having a surface roughness Ra of approximately 0.55 μm determined on the basis of the above-described condition, with the contact angle θ illustrated in FIG. 9 changed from 10 degrees to 35 degrees in increments of 5 degrees. According to the experiment, when the contact angle θ was set to 10 degrees, a flat portion of the collecting blade 24 came into contact with the collecting roller 23 due to a relatively low coefficient of friction between the collecting blade 24 and the collecting roller 23. As a result, a cleaning failure occurred with the toner density ID exceeding the value of approximately 0.01. When the contact angle θ was set to at least 15 degrees, however, the cleaning was successfully performed with the toner density ID not exceeding the value of approximately 0.01.

When the collecting blade 24 was replaced by an existing urethane rubber blade, the cleaning was successfully performed with the contact angle θ of 10 degrees in the initial state. When the contact angle θ was set to at least 30 degrees, however, the urethane rubber blade was turned over due to the coefficient of friction between the blade and the collecting roller 23. Meanwhile, the metal collecting blade 24 is not turned over. Further, the coefficient of friction between the metal collecting blade 24 and the collecting roller 23 is relatively low, and thus the drive torque for driving the collecting roller 23 is reduced.

As described above, if the collecting roller 23 and the collecting blade 24 are made of metal, and if the surface roughness Ra of the section of the collecting blade 24 in contact with the collecting roller 23 is set not to exceed approximately 2.0 μm, it is possible to obtain long-term stable characteristics of the collecting roller 23 and the collecting blade 24 with little abrasion. Further, if the contact angle θ of the collecting blade 24 relative to the collecting roller 23 is set to at least 15 degrees, it is possible to obtain reliable cleaning performance by preventing the turnover of the collecting blade 24 and the contact of a flat portion of the collecting blade 24 with the collecting roller 23.

Toner Producing Method and Shape Factor SF1:

Due to digitization and multi-functionalization in the field of electrophotography, a demand for higher image quality has been increasing than ever before. Accordingly, a reduction in diameter of toner particles has been demanded to improve the image quality reproducibility. Further, a demand for a reduction in environmental burden in the toner production process has also been increasing from the society increasingly aware of energy savings. Among existing toner producing methods, the melting-kneading-pulverizing method has been mainstream. According to the method, however, the productivity is reduced along with a reduction in diameter of toner particles. As a result, the production cost and the environmental burden produced in the production process are increased. Meanwhile, the polymerization method, which is one of recently used toner producing methods, makes it relatively easy to control a small and sharp particle diameter distribution, and allows structural control of a toner containing a coloring agent, a wax, and so forth. For the above reasons, the polymerization method has been drawing attention. However, unlike a normal toner producing process which increases the shape factor SF1 (described later) of toner particles, the polymerization method makes it difficult to perform the existing blade cleaning operation. Therefore, the polymerization method, which reduces the shape factor SF1, is added with a deformation process to increase the shape factor SF1 and thereby allow the blade cleaning. The deformation process, however, increases costs.

The shape factor SF1 used here for describing toner particles is a numeric value representing the degree of sphericity of the shape of a spherical object. When MXLNG represents the maximum length of an ellipse formed by projection of a spherical object into a two-dimensional planar shape and AREA represents the area of the ellipse, the square of the maximum length MXLNG is divided by the ellipse area AREA and multiplied by a value 100π/4. A resultant value represents the shape factor SF1. That is, the shape factor SF1 is represented by the equation:

SF1={(MXLNG)²/AREA}×(100π/4).

If toner particles have a shape factor SF1 of 100, the shape of the toner particles is a complete sphere. As the shape factor SF1 is increased, the toner particles have a more indeterminate form. In general, as the shape of toner particles approaches a spherical shape, the state of contact between the toner particles or between the toner particles and an image carrying member shifts to point contact. As a result, the adsorption force acting between the toner particles is reduced, and the fluidity of the toner particles is increased. Further, the adsorption force acting between the toner particles and the image carrying member is also reduced, and thus the toner transfer rate is increased.

In an embodiment of the present invention, the toner was obtained by the following procedure. A toner composition containing a coloring agent and a binder resin containing a denatured polyester-based resin, which may have a urea bond, is dissolved or dispersed in an organic solvent. Then, the toner composition is converted into particles and subjected to polyaddition reaction in the water solvent. Thereafter, the solvent is removed from a resultant dispersion liquid, and the toner particles are cleaned and dried. As the toner producing method for obtaining spherical toner particles, a commonly used polymerization method other than the above-described producing method may be used. For example, a polymerization method such as an emulsion polymerization method, a suspension polymerization method, and a dispersion polymerization method may be used. Further, a toner obtained by an existing pulverization method and subjected to ensphering method using heat treatment may be used.

A cleaning device according to an embodiment of the present invention will now be described. An experiment for examining the cleaning life was conducted under the following conditions.

The brush roller 22 is made of conductive PET fiber, and has an outer diameter of approximately 15 mm, a core bar diameter of approximately 6 mm, a resistance of approximately 10⁷Ω·cm, a brush bristle density of approximately 100,000/in², and a rotation speed of approximately 250 mm/s (millimeters per second). Further, the brush roller 22 is rotated in the opposite direction to the rotation direction of an image carrying member, and bites into the image carrying member by a depth of approximately 1 mm. Further, the brush roller 22 is applied with a voltage of approximately 1.6 kV (kilovolts).

The collecting roller 23 is made of a SUS material, and has an outer diameter of approximately 14 mm, a surface roughness Ra of approximately 0.5 μm, and a rotation speed of approximately 250 mm/s. Further, the collecting roller 23 is rotated in the opposite direction to the rotation direction of the brush roller 22, and bites into the brush roller 22 by a depth of approximately 1.5 mm. Further, the collecting roller 23 is applied with a voltage of approximately 2.0 kV.

The collecting blade 24 is made of a SUS material, and has a thickness of approximately 0.08 mm, a free length of approximately 8 mm, and a surface roughness Ra of approximately 0.55 μm. Further, the collecting blade 24 is pressed into the collecting roller 23 by a depth of approximately 1 mm.

A cleaning failure did not occur in continuous printing of 500,000 images performed under the above-described conditions with the use of an A4-size 5% test chart.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, position, and shape of components are not limited the embodiments and thus may be preferably set. It is therefore to be understood that within the scope of the appended claims, the disclosure of this patent specification may be practiced otherwise than as specifically described herein.

1. A cleaning device for an electrophotographic image forming apparatus, the cleaning device comprising:
a primary cleaning brush configured to remove post-transfer residual toner remaining on an image carrying member;
a collecting roller configured to cause the post-transfer residual toner adhering to the primary cleaning brush to electrostatically adhere thereto, made of metal, and having a surface roughness Ra of at least approximately 0.08 micrometers; and
a blade configured to come into contact with the collecting roller and mechanically remove the post-transfer residual toner adhering to the collecting roller.

2. The cleaning device according to claim 1, wherein the surface roughness Ra of the collecting roller does not exceed approximately 1.6 micrometers.

3. The cleaning device according to claim 2, wherein the blade is made of metal, and includes a section coming into contact with the collecting roller and having a surface roughness Ra not exceeding approximately 2.0 micrometers.

4. The cleaning device according to claim 1, wherein the angle of contact of the blade with the collecting roller is at least approximately 15 degrees.

5. An image forming apparatus comprising a cleaning device according to claim 1.

6. The image forming apparatus according to claim 5, wherein the toner is produced by a polymerization method.

7. The image forming apparatus according to claim 5, wherein the toner is produced by a pulverization method subjected to an ensphering process using heat treatment.
